(19) United States
(12) Patent Application Publication
(10) Pub. No.: US 2015/0158035 A1
(43) Pub. Date: Jun. 11, 2015

(54) HIGH-SEAL ATOMIZING NOZZLE STRUCTURE

(71) Applicant: CHIH LUNG HSU, Taichung City (TW)

(72) Inventor: CHIH LUNG HSU, Taichung City (TW)

(21) Appl. No.: 14/100,150

(22) Filed: Dec. 9, 2013

(51) Int. Cl. B05B 1/26

(52) U.S. Cl. CPC B05B 1/265

(57) ABSTRACT

A high-seal atomizing nozzle structure includes an assembly composed of a first body and a second body assembled together, and a rotor and a water stopping plug assembly mounted in the assembly. More particularly, a connection portion between the first body and the second body has an accommodating structure in which an anti-leakage ring is mounted. Thus, the anti-leakage ring may be hidden in the assembly to ensure the seal between the first body and the second body, and the breakage of the anti-leakage ring can be avoided. The accommodating structure may be composed of an annular groove and a pressing shoulder disposed opposite each other, or two opposite annular grooves.

### BACKGROUND OF THE INVENTION

1. Field of the Invention

The invention relates to the technical field of an atomizing nozzle and more particularly to an atomizing nozzle structure having a first body and a second body, which can be sealed to form an atomizing nozzle.

2. Related Art

An atomizing nozzle may be composed of a first body and a second body assembled together to form an assembly through which a liquid may flow. In order to prevent the liquid from leaking, an anti-leakage ring (e.g., an O-ring) is typically disposed between an assembled position between the first body and the second body so as to achieve the anti-leakage and anti-penetration effects.

The anti-leakage ring is disposed between the first body and the second body so that a sandwich structure is formed. In order to make the anti-leakage ring have the better anti-leakage effect, the first body and the second body need to be further closed upon each other, so that the end surfaces of the first body and the second body can apply a suitable pressure to the anti-leakage ring to deform the anti-leakage ring.

Because the anti-leakage ring is interposed between two flat end surfaces, the end surface of the first body and the end surface of the second body do not completely press against each other. Thus, the assembled outlook is poor, and the anti-leakage ring may be exposed and tend to age and break so that the anti-leakage effect becomes deteriorated or failed in a short period of time.

### SUMMARY OF THE INVENTION

An object of the invention is to provide a high-seal atomizing nozzle structure, in which two members constituting the atomizing nozzle can effectively closely contact with each other to achieve the seal, and an anti-leakage ring between the two members can be hidden, so that the aging time of the anti-leakage ring can be lengthened, and the breakage of the anti-leakage ring can be avoided. Thus, the atomizing nozzle has the higher use efficiency and the longer lifetime.

To achieve the above-identified object and effect, the invention discloses an atomizing nozzle including a first body, a second body, a rotor, an accommodating structure and an anti-leakage ring. The first body has one end formed with an atomizing end surface and the other end formed with a first connection end surface. A spray hole is formed on the atomizing end surface, and a first channel connected to the spray hole is axially formed in the first body. The second body is axially formed in a second channel, and has one end formed with a second connection end surface. The second body is combined with the first body so that the first channel and the second channel communicate with each other, and the second connection end surface corresponds to the first connection end surface. The rotor is disposed in a chamber formed by the first channel and the second channel communicating with each other. The accommodating structure is disposed on the first connection end surface and the second connection end surface. The accommodating structure includes a first annular groove and a pressing shoulder. The anti-leakage ring is mounted in the first annular groove of the accommodating structure and pressed by the pressing shoulder.

In addition, the atomizing nozzle may include a first body, a second body, a rotor, an accommodating structure and an anti-leakage ring. The first body has one end formed with an atomizing end surface, and the other end formed with a first connection end surface. A spray hole is formed on the atomizing end surface, and the first body has an axially formed first channel connected to the spray hole. The second body is axially formed with a second channel and has one end formed with a second connection end surface. The second body is combined with the first body so that the first channel and the second channel communicate with each other, and the second connection end surface corresponds to the first connection end surface. The rotor is disposed in a chamber formed by the first channel and the second channel communicating with each other. The accommodating structure comprises a first annular groove formed on the first connection end surface of the first body, and a second annular groove formed on the second connection end surface of the second body. The anti-leakage ring is mounted in the chamber formed by the first annular groove and the second annular groove disposed opposite each other.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an exploded view showing a first embodiment of the invention.

FIG. 2 is a schematically assembled illustration showing the first embodiment of the invention.

FIG. 3 is a schematically assembled illustration showing a second embodiment of the invention.

FIG. 4 is a schematically assembled illustration showing a third embodiment of the invention.

### DETAILED DESCRIPTION OF THE INVENTION

The present invention will be apparent from the following detailed description, which proceeds with reference to the accompanying drawings, wherein the same references relate to the same elements.

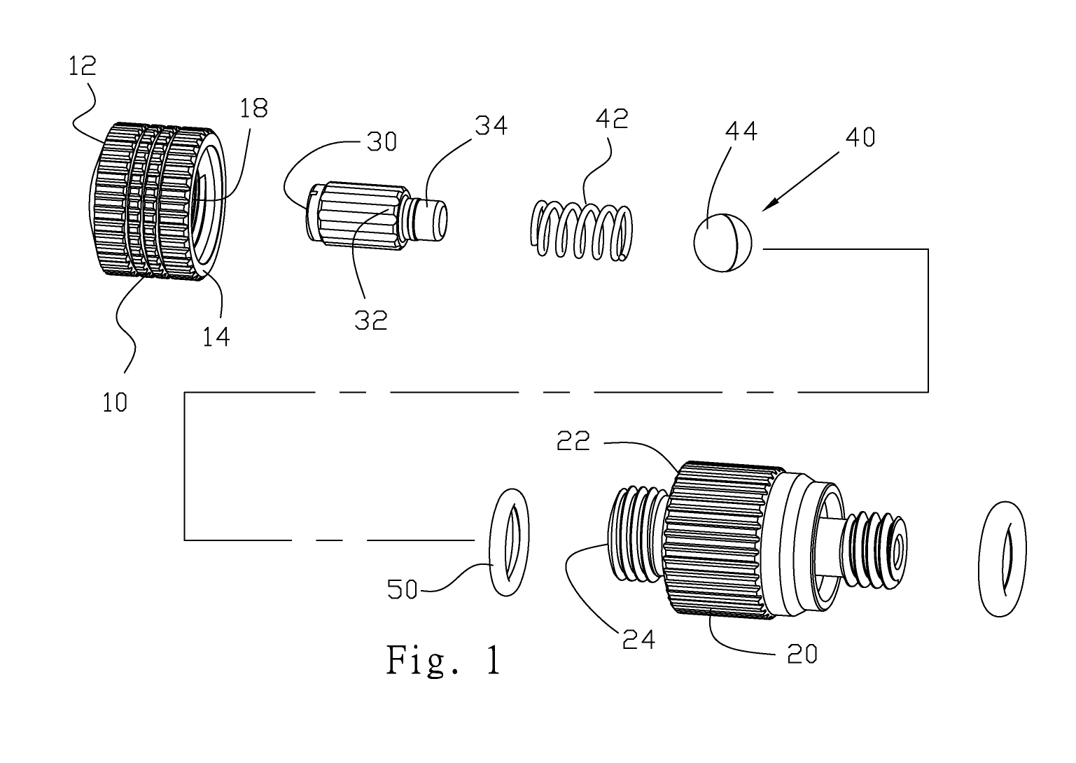

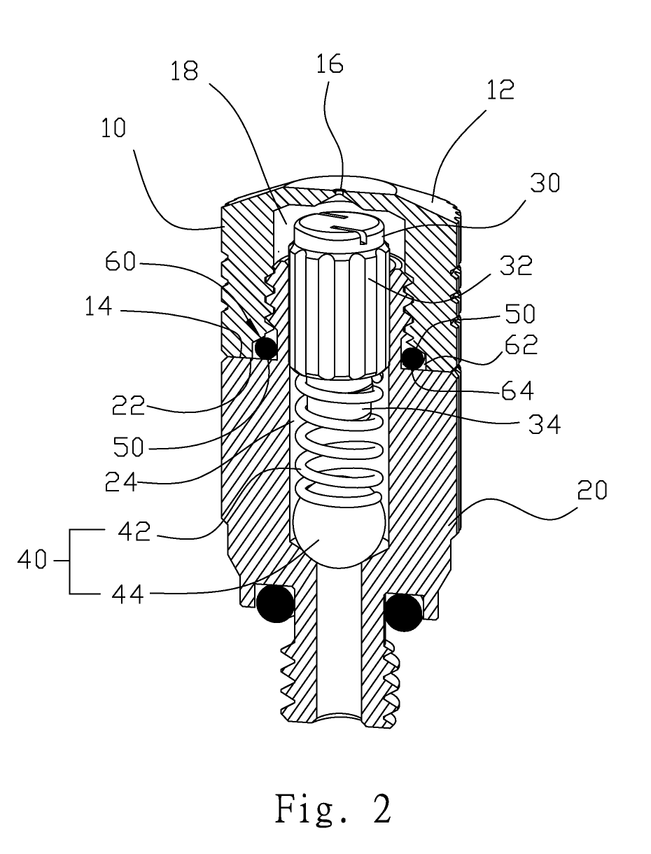

Referring to FIGS. 1 and 2, the atomizing nozzle includes a first body (10), a second body (20), a rotor (30) and a water stopping plug assembly (40). The first body (10) and the second body (20) may be combined together by way of screwing. The rotor (30) and the water stopping plug assembly (40) are mounted in the assembly of the first body (10) and the second body (20).

Furthermore, the first body (10) has one end formed with an atomizing end surface (12), and the other end formed with a first connection end surface (14). A spray hole (16) (see FIG. 2) is formed on the atomizing end surface (12), and the first body (10) is axially formed with a first channel (18) connected to the spray hole (16).

The second body (20) has one end formed with a second connection end surface (22), and is axially formed with a second channel (24). The second body (20) is combined with the first body (10) so that the first channel (18) and the second channel (24) communicate with each other, and the second connection end surface (22) corresponds to the first connection end surface (14).

The rotor (30) is disposed in the chamber (see FIG. 2) formed by the first channel (18) and the second channel (24) communicating with each other. The surface of the rotor (30) has a plurality of ribs (32), and the neighboring ribs (32) are parallel to each other. Also, the water stopping plug assembly (40) is composed of a spring (42) and a valve ball (44) and is disposed on one end of the rotor (30). Furthermore, the spring (42) is to be connected to a connection section (34) of the one end of the rotor (30). The valve ball (44) may have a ball shape or any other shape. In addition, an anti-leakage ring (50) is disposed between the first body (10) and the second body (20).

Referring to FIG. 2, it is to be noted that an accommodating structure (60) for accommodating and positioning the anti-leakage ring (50) is disposed between the first body (10) and the second body (20). Furthermore, the accommodating structure (60) includes a first annular groove (62) and a pressing shoulder (64), wherein the first annular groove (62) is formed on the first connection end surface (14), and the pressing shoulder (64) is the second connection end surface (22). The anti-leakage ring (50) is accommodated within the first annular groove (62) and is pressed and positioned by the pressing shoulder (64).

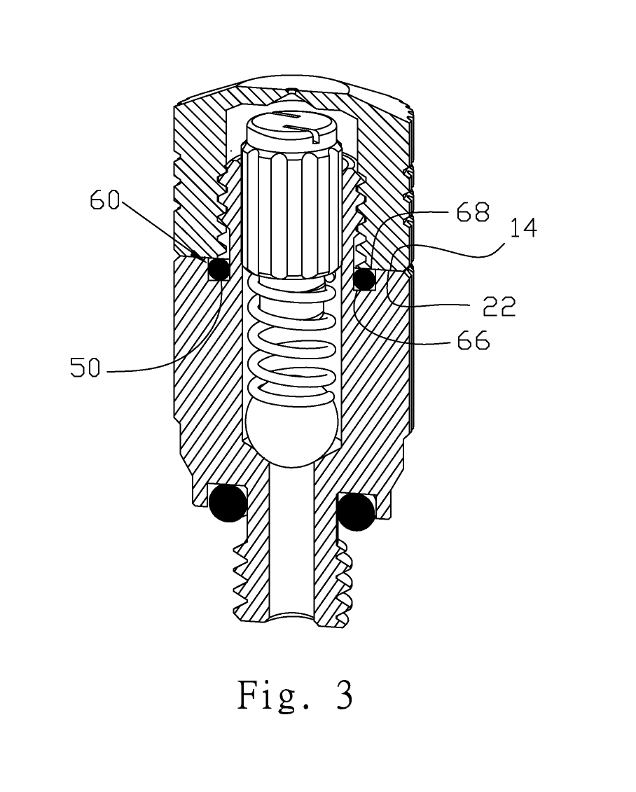

Referring to FIG. 3, the accommodating structure (60) includes a second annular groove (66) and a pressing shoulder (68), wherein the second annular groove (66) is formed on the second connection end surface (22), and the pressing shoulder (68) is the first connection end surface (14). The anti-leakage ring (50) is fit within the accommodating structure (60). Furthermore, the anti-leakage ring (50) is accommodated within the second annular groove (66) and is pressed and positioned by the pressing shoulder (68).

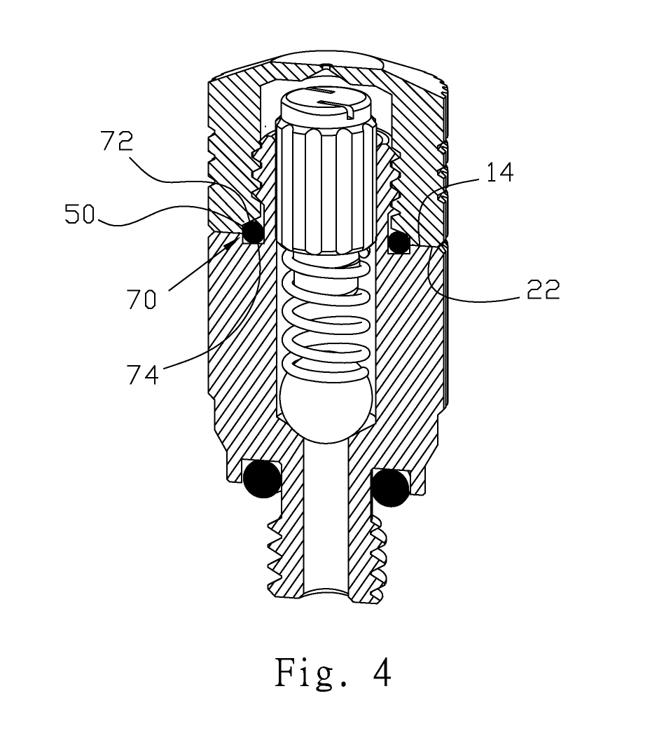

FIG. 4 shows an accommodating structure (70) of another embodiment. The accommodating structure (70) includes a first annular groove (72) and a second annular groove (74), wherein the first annular groove (72) is formed on the first connection end surface (14), and the second annular groove (74) is formed on the second connection end surface (22). The anti-leakage ring (50) is fit within the accommodating structure (70). Furthermore, a portion of the anti-leakage ring (50) is accommodated within the first annular groove (72), the other portion of the anti-leakage ring (50) is accommodated within the second annular groove (74), and the anti-leakage ring (50) is pressed by the bottom surfaces of the two annular grooves.

Each of the atomizing nozzles of FIGS. 3 and 4 has the rotor (30) and the water stopping plug assembly (40). The structures or assembling forms of the rotor (30) and the water stopping plug assembly (40) disclosed in FIGS. 3 and 4 are the same as those disclosed in FIGS. 1 and 2, so detailed descriptions thereof will be omitted.

As shown in FIGS. 2, 3 and 4, the anti-leakage ring (50) is accommodated within the accommodating structure (60) or (70). After the first body (10) and the second body (20) are assembled into the assembly, the anti-leakage ring (50) may be disposed in the assembly in a hidden manner. Thus, the anti-leakage ring (50) can achieve the anti-leakage effect on the assembly, and the unexposed anti-leakage ring (50) may also reduce the possibility of breakage.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A high-seal atomizing nozzle structure, comprising:
a first body having one end formed with an atomizing end surface and the other end formed with a first connection end surface, wherein a spray hole is formed on the atomizing end surface, and a first channel connected to the spray hole is axially formed in the first body;
a second body axially formed in a second channel, wherein the second body has one end formed with a second connection end surface, the second body is combined with the first body so that the first channel and the second channel communicate with each other, and the second connection end surface corresponds to the first connection end surface;
a rotor disposed in a chamber formed by the first channel and the second channel communicating with each other;
an accommodating structure disposed on the first connection end surface and the second connection end surface, wherein the accommodating structure includes a first annular groove and a pressing shoulder; and
an anti-leakage ring mounted in the first annular groove of the accommodating structure and pressed by the pressing shoulder.

2. The atomizing nozzle structure according to claim 1, wherein the first annular groove of the accommodating structure is formed on the first connection end surface of the first body, and the pressing shoulder is the second connection end surface of the second body.

3. The atomizing nozzle structure according to claim 1, wherein the first annular groove of the accommodating structure is formed on the second connection end surface of the second body, and the pressing shoulder is the first connection end surface of the first body.

4. The atomizing nozzle structure according to claim 1, further comprising a water stopping plug assembly, which is a combination of a spring and a valve ball, and disposed on one end of the rotor.

5. The atomizing nozzle structure according to claim 4, wherein the one end of the rotor has a connection section to be combined with the spring.

6. The atomizing nozzle structure according to claim 1, wherein a surface of the rotor is formed with a plurality of ribs, and neighboring ribs of the plurality of ribs are parallel to each other.

7. The atomizing nozzle structure according to claim 4, wherein a surface of the rotor is formed with a plurality of ribs, and neighboring ribs of the plurality of ribs are parallel to each other.

8. A high-seal atomizing nozzle structure, comprising:
a first body having one end formed with an atomizing end surface, and the other end formed with a first connection end surface, wherein a spray hole is formed on the atomizing end surface, and the first body has an axially formed first channel connected to the spray hole;
a second body, which is axially formed with a second channel and has one end formed with a second connection end surface, wherein the second body is combined with the first body so that the first channel and the second channel communicate with each other, and the second connection end surface corresponds to the first connection end surface;
a rotor disposed in a chamber formed by the first channel and the second channel communicating with each other;
an accommodating structure comprising a first annular groove formed on the first connection end surface of the first body, and a second annular groove formed on the second connection end surface of the second body; and
an anti-leakage ring mounted in the chamber formed by the first annular groove and the second annular groove disposed opposite each other.

9. The atomizing nozzle structure according to claim 8, further comprising a water stopping plug assembly, wherein the water stopping plug assembly is a combination of a spring and a valve ball, and the water stopping plug assembly is disposed on one end of the rotor.

10. The atomizing nozzle structure according to claim 9, wherein the one end of the rotor has a connection section to be combined with the spring.

11. The atomizing nozzle structure according to claim 8, wherein a surface of the rotor is formed with a plurality of ribs, and neighboring ribs of the plurality of ribs are parallel to each other.

12. The atomizing nozzle structure according to claim 9, wherein a surface of the rotor is formed with a plurality of ribs, and neighboring ribs of the plurality of ribs are parallel to each other.
